(19) United States
(12) Patent Application Publication
(10) Pub. No.: US 2021/0297516 A1
(43) Pub. Date: Sep. 23, 2021

(54) UNIVERSAL SCREEN PROTECTOR ATTACHING MACHINE

(71) Applicant: Wing Tak Lee Silicone Rubber Technology (Shenzhen) Co., Ltd, Shenzhen (CN)

(72) Inventor: Tak Nam LIU, Shenzhen (CN)

(21) Appl. No.: 17/207,857

(22) Filed: Mar. 22, 2021

(30) Foreign Application Priority Data
Mar. 23, 2020 (CN) 202020383802.6

(51) Int. Cl. H04M 1/02; H04M 1/18

(52) U.S. Cl. CPC H04M 1/0266; H04M 2201/38; H04M 1/18

(57) ABSTRACT

The embodiments of the present application provide a universal screen protector attaching machine which comprises an outer frame that corresponds to smart phones, upper positioning nails that correspond to the positioning holes at the upper end of the outer frame, lower positioning nails that correspond to the positioning holes at the bottom end of the outer frame, and at the inner surface of the bottom of the outer frame, a detachable buckle that corresponds to smart phone charging plugs. The technical solution provided by this application improves the user experience.

### CROSS REFERENCE TO RELATED APPLICATION

The present application claims priority to China patent application No. 202020383802.6, entitled “UNIVERSAL SCREEN PROTECTOR ATTACHING MACHINE” filed on Mar. 23, 2020, the entire content of which is incorporated herein by reference.

### TECHNICAL FIELD

The present application relates to the field of smartphone accessories technology, and in particular, to a universal screen protector attach machine.

### BACKGROUND

A screen protector attaching machine is specialised equipment for attaching screen protectors to smart phones. The existing smart phone screen protector attaching machines, however, do not support changes in smart phone models. Therefore, when the phone model changes, the screen protector attaching machine needs to be replaced. This problem makes it inconvenient for users to utilise the smart phone screen protector attaching, machine, thereby affecting the user experience.

### SUMMARY

The embodiments of the present application disclose a universal screen protector attaching machine which supports a variety of smart phone models and therefore improves the user experience.

The first embodiment of the present application discloses a universal screen protector attaching machine, which comprises an outer frame that corresponds to a smart phone, an upper positioning nail that corresponds to the positioning holes at the upper end of the outer frame, a lower positioning nail that corresponds to the positioning holes at the bottom end of the outer frame, and a detachable buckle that corresponds to smart phone charging plugs which is arranged at the inner surface of the bottom of the outer frame.

In the implementation of the embodiments of the present application, the technical solution of the present application provides a detachable buckle at the bottom of the screen protector attaching machine, which adapts to varied smart phone models, so that varied smart phone models are supported by one screen protector attaching machine, and the user experience is improved.

### BRIEF DESCRIPTION OF THE DRAWINGS

To more clearly illustrate the technical solution in the embodiments of the present disclosure, drawings used in the description of the embodiments will be briefly described below. Obviously, the drawings in the following description are some embodiments of the present disclosure. Those skilled in art can also obtain other drawings based on these drawings without any creative efforts.

FIG. 1 is a schematic diagram of a universal screen protector attaching machine provided by the present application.

FIG. 2 is a schematic diagram of a buckle provided by the present application.

FIG. 3 is an enlarged perspective view of the positioning of the buckle provided by the present application.

### DETAILED DESCRIPTION OF THE INVENTION

The technical solution in the embodiments of the present disclosure is clearly and completely described below with reference to the accompanying drawings in the embodiments of the present disclosure. Obviously, the described embodiments are a part of the embodiments of the present disclosure, rather than all of the embodiments. All other embodiments obtained by those skilled in the art based on the embodiments of the present disclosure without paying any creative efforts are within the scope of protection of the present disclosure.

It should be understood that the term “and/or” as employed herein is merely an association describing the associated objects, indicating that there may be three types of relationship, for example, A and/or B, which may indicate: A exists separately, A and B coexist; there is B alone. Additionally, “/” in this text indicates either one of two associated objects are possible.

The term “plurality” in the embodiments of the present application means two or more. The descriptions of the first, second, etc. in the embodiments of the present application are only for illustrating and differentiating the objects, and do not represent the order or the particular limitation of the number of the devices in the embodiments of the present application, and do not constitute any limitation to the embodiments of the present application. The term “connect” in the embodiments of the present application refers to various connection manners, such as direct connection or indirect connection, to implement communication between devices, which is not limited in this embodiment of the present application.

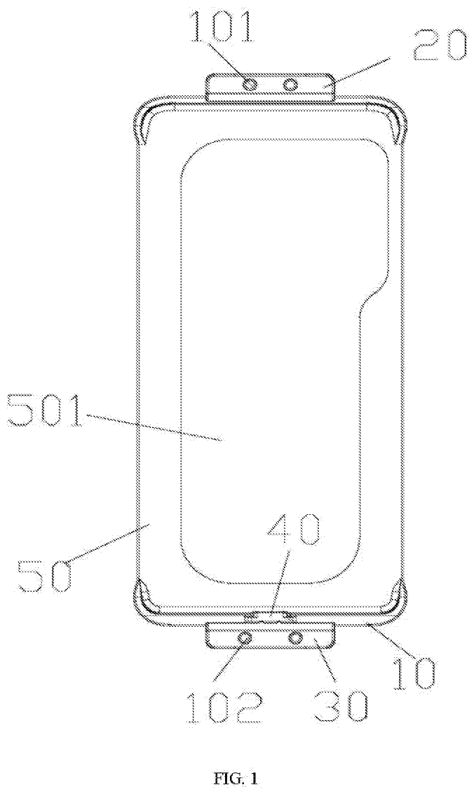

Referring to FIG. 1, FIG. 1 shows a universal screen protector attaching machine. As shown in FIG. 1, the universal screen protector attaching machine comprises an outer frame 10 that matches to a smart phone, two upper positioning nails 101 that correspond to the positioning holes at the upper end 20 of the outer frame, two lower positioning nails 102 that correspond to the positioning holes at the bottom end 30 of the outer frame 10, a detachable buckle 40 which is arranged at the inner surface of the bottom end 30 of the outer frame, and corresponds to a smart phone charging plug.

The technical solution of the present application provides a detachable buckle which adapts to varied smart phone models at the bottom end of the screen protector attaching machine, so that varied mobile phone models are supported by one screen protector attaching machine.

Optionally, the above said buckle 40 may preferably be any one selected from a group consisting of a type-C buckle (for Android phones such as Huawei and Xiaomi smart phones), a Lightning buckle (for iPhones), and a mini USB buckle (for Oppo, Vivo smart phones, etc.) and their combination.

The detachable buckle 40 disposed on the inner surface 33 of the bottom end 30 of the outer frame may preferably include:

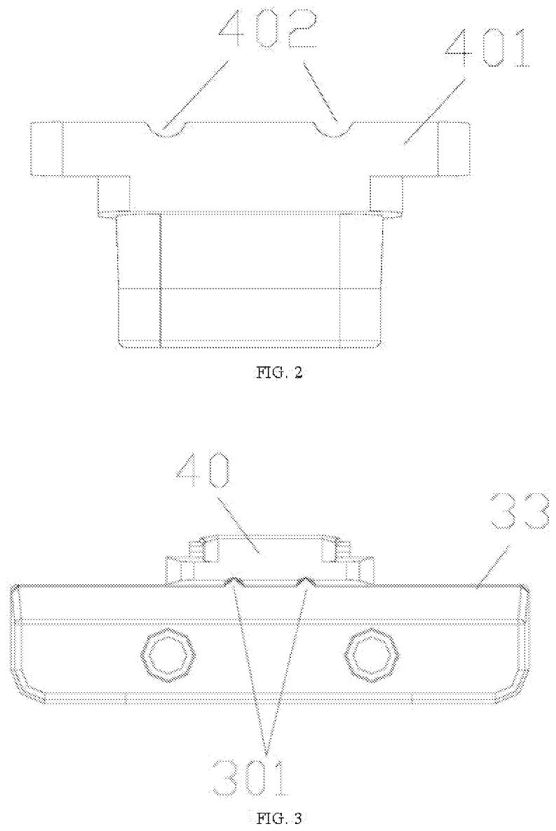

As shown in FIG. 2 and FIG. 3, a groove 402 is disposed on one side 401 of the buckle 40, and a protrusion 301 is disposed on the inner side of the bottom end 30 of the outer frame 10 to correspond to the groove 402. In practical applications, the reverse that a groove is disposed at the bottom end 30 and a protrusion is disposed on one side of the buckle can also be applied.

Optionally, the above said upper positioning nails 101 are two upper positioning nails 101 arranged in a mirror image (mirroring along the vertical centre line of the screen protector attaching machine).

Optionally, the above said lower positioning nails 102 are two lower positioning nails 102 arranged in a mirror image (mirroring along the vertical centre line of the screen protector attaching machine).

The working principle on which the universal screen protector attach machine supports changes in smart phone models will be elaborated below. Two types of smart phone models, such as Huawei and iPhone which may or may not be in the same size, can be taken as examples. For an iPhone, the buckle can be replaced with a Lightning buckle for positioning the phone. Whereas for a Huawei smart phone, this buckle can be replaced with a type-C buckle can be replaced with for positioning the phone.

In addition, although the size of a Huawei smart phone may vary, when its size is smaller than the inner surface of the outer frame of the universal screen protector attaching machine, the screen attachment can be completed. Although the outer frame may not effectively position the smart phone, the buckle is fixed on the screen protector attaching machine and it can be directly inserted into the charging port of the mobile phone so it is capable to do so. When the positioning holes of the screen protector on the outside of the film (the screen protector is generally called No. 1 screen film) are corresponding to the upper and lower positioning nails on the screen protector attaching machine at the same time, the screen protector attaching machine will be able to attach a screen protector onto a smart phone smaller than the outer frame. As such, the universal screen protector can support changes in mobile phone models, thereby improving the user experience.

Optionally, the opening 501 is disposed at the bottom 50 of the outer frame 10.

The opening 501 can facilitate the phone camera to go through the opening and resolve the problem that prominent phone cameras hinder smart phones from being placed flat in a screen protector attaching machine. As currently the rear cameras of many smart phones are designed to be prominent, such as Redmi K30, iPhone 11, Huawei mate 30 series, etc., the rear cameras are all higher than the bottom surface of the phone. Suppose there is no opening disposed at the bottom of the universal screen protector attaching machine. the camera tends to lift the phone up and therefore the phone cannot be placed flat.

Optionally, the thickness of the bottom 50 of the outer frame 10 is bigger than the set size (i.e. threshold) which can be set as 5 mm or any other size as long as the thickness of the bottom 50 is bigger than the protruding height of the camera. This design enables the general screen protector attaching machine to be placed on any flat surface, which allows the attaching machine to be utilised in more occasions.

In the above embodiments, the description of each of the embodiments has its own emphasis, and the parts that are not detailed in a certain embodiment can refer to the related descriptions of other embodiments.

In the several embodiments provided by the present application, it should be understood that the disclosed device may be implemented in other ways. For example, the device embodiments described above are merely illustrative. For example, the division of the unit is only a logical function division. In actual implementation, there may be another division manner. For example, a plurality of units or components may be combined or may be integrated into another system, or some features may be ignored or not executed. In addition, the mutual coupling, direct coupling or communication connection shown or discussed may be an indirect coupling or communication connection through some interfaces, devices or unites, and may be electrical or in other forms.

The unit illustrated as a separating component may or may not be physically separate. The component displayed as a unit may or may not be a physical unit. That is, the component displayed as a unit can be placed in one location or distributed to multiple network units. Some or all of units therein can be selected to meet the purpose of the embodiments of the present application based on actual needs.

The embodiments of the present application have been described in detail above. Specific examples are applied herein to set forth the principle and implementation of the present application. The description of the above embodiments is only used to help understand the method and core ideas of the present application; at the same time, those skilled in the art will have a change in the specific implementation and the scope of the application according to the idea of the present application. In summary, the content of the present specification should not be construed as limiting the present application.

What is claimed is:

1. A universal screen protector attaching machine comprising:
an outer frame matched with a mobile phone;
an upper positioning nail which is provided on top of the outer frame and corresponds to a first positioning hole,
a lower positioning nail which is provided at a bottom of the outer frame and corresponds to a second positioning, hole; and
a detachable buckle which is arranged at an inner surface of the bottom of the outer frame and corresponds to a smart phone charging plug.

2. The universal screen protector attaching machine of claim 1, wherein the detachable buckle is one selected from a group consisting of a type-C buckle, a Lightning buckle, a mini USB buckle and a combination thereof.

3. The universal screen protector attaching machine of claim 1, wherein a groove is provided on one side of the detachable buckle, and a protrusion matching with the groove is provided on the inner side of the bottom end of the outer frame.

4. The universal screen protector attaching machine of claim 1, wherein a protrusion is provided on one side of the detachable buckle, and a groove matching with the protrusion is provided on the inner side of the bottom end of the outer frame.

5. The universal screen protector attaching machine of claim 1, wherein there are two upper positioning nails, which are arranged in a mirror image.

6. The universal screen protector attaching machine of claim 1, wherein there are two lower positioning nails, which are arranged in a mirror image.

7. The universal screen protector attaching machine of claim 1, wherein an opening is disposed at a bottom of the outer frame.

8. The universal screen protector attaching machine of claim 1, wherein the bottom of the outer frame has a thickness larger than a threshold.
